(19) United States
(12) Patent Application Publication
(10) Pub. No.: US 2022/0417576 A1
(43) Pub. Date: Dec. 29, 2022

(54) Advertisement Selection for Ad-Supported Video

(71) Applicant: WURL INC., Palo Alto, CA (US)

(72) Inventors: Ron Gutman, San Diego, CA (US); Noam Koren, Los Gatos, CA (US); Yuval Fisher, Palo Alto, CA (US); David Martinez, Brentwood, CA (US); Sean Doherty, Palo Alto, CA (US); Nam Hung Ly, Sunnyvale, CA (US)

(21) Appl. No.: 17/359,569

(22) Filed: Jun. 27, 2021

(51) Int. Cl. H04N 21/2668; G06Q 30/02; G06N 20/00; G06N 5/04; H04N 21/234; H04N 21/81; H04N 21/25; H04N 21/24

(52) U.S. Cl. CPC H04N 21/2668; G06Q 30/0243; G06Q 30/0269; G06Q 30/0246; G06Q 30/0201; G06Q 30/0275; G06N 20/00; G06N 5/04; H04N 21/23424; H04N 21/812; H04N 21/252; H04N 21/2407

(57) ABSTRACT

A method of assigning advertisements to slots in video channels of a bundle of channels provided to an end user. The method includes managing credits, for each specific channel of the channels, indicative of a difference between a number of advertisements provided by an owner of the specific channel that were displayed on other channels and a number of advertisements provided by owners of other channels displayed on the specific channel In addition, scores indicative of a predicted success of the advertisement with the end user are calculated for a plurality of advertisements. An advertisement to be displayed to the end user is selected responsive to a function of both the calculated scores and the managed credits.

### FIELD OF THE INVENTION

The present invention relates generally to communication systems, and particularly to methods and systems for processing video signals.

### BACKGROUND OF THE INVENTION

Many television users are provided with bundles of many channels including a wide variety of content. Some channels are provided only to paying subscribers, while others, referred to as Free Ad Supported TV (FAST) channels, are provided at no charge to the end customer and are supported by advertisement revenue. Generally, FAST channels are provided in bundles including dozens or even hundreds of channels.

Video streams are designed with slots, also known as avails, to be filled in with advertisements when the stream is provided to a specific end customer. Not all slots are filled by advertisers, and owners typically fill those slots with promotional ads. While showing promotional ads to existing viewers may increase their engagement, it has diminishing value at high frequency. It is more desirable to attract new viewers.

### SUMMARY OF THE INVENTION

Some aspects of embodiments of the present invention provide a method of assigning advertisements to slots in video channels of a bundle of channels provided to an end user, comprising managing credits, for each specific channel of the channels, indicative of a difference between a number of advertisements provided by an owner of the specific channel that were displayed on other channels and a number of advertisements provided by owners of other channels displayed on the specific channel, calculating, for a plurality of advertisements, scores indicative of a predicted success of the advertisement with the end user; and selecting an advertisement to be displayed to the end user, responsive to a function of both the calculated scores and the managed credits.

Optionally, managing the credits comprises assigning different numbers of credits for displaying advertisements, responsive to attributes of a viewer to which the advertisements are displayed. Optionally, managing the credits comprises assigning different numbers of credits for displaying advertisements, responsive to attributes of a device on which the advertisements are displayed. Optionally, calculating the scores comprises calculating by a machine learning engine. Optionally, calculating the scores comprises training the machine learning engine to identify end users having features similar to users who following the viewing of a promotional advertisement, viewed the channel promoted by the promotional advertisement. Optionally, calculating the scores comprises training the machine learning engine based on tracking viewership of similar users. Optionally, calculating the scores comprises training the machine learning engine based on features of the viewership of the video channels by a plurality of end users, and conversion information on the end users. Optionally, calculating the scores comprises calculating Pearson correlation based recommendations. Optionally, calculating the scores comprises calculating a prediction of a duration the end user will view a channel promoted by the advertisement, following viewing the advertisement. Optionally, calculating the scores comprises calculating a prediction of an increase in a time the user will spend in viewing the channels of the bundle, following viewing the advertisement. Optionally, selecting the advertisement to be displayed comprises selecting responsive to a weighted sum of the calculated scores and the managed credits. Optionally, the method includes periodically updating weights of the weighted sum. Optionally, selecting the advertisement to be displayed comprises selecting for slots that were not filled in a bidding based on payment. Optionally, the method includes setting for each of the channels a cap on the number of credits it may consume per a given period, and wherein selecting the advertisement to be displayed is performed additionally responsive to the caps of the channels. Optionally, setting the cap of each channel comprises calculating an average rate of credit generation by the channel and setting the cap responsive to the set calculated average.

There is further provided in accordance with embodiments of the present invention, a method of controlling broadcast of video channels, comprising filing bids for a plurality of slots in a plurality of broadcast channels transmitted to end users, wherein the bids are filed with low price offers, receiving bid logs, by a processor, responsive to the filed bids, grouping entries of the received bid logs into single-session groups, by the processor, estimating a session duration for each of the single-session groups, and controlling, by the processor, supply of broadcast channels to one or more of the end users, responsive to the estimated session durations. Optionally, filing the bids comprises filing on channels of a plurality of different service providers. Optionally, grouping the entries comprises grouping entries into groups of the same user ID, service provider ID and content identifier. Optionally, grouping the entries comprises grouping the entries, such that entries separated by a time longer than a threshold are considered as belonging to different groups.

There is further provided in accordance with embodiments of the present invention, an apparatus for assigning advertisements to slots in video channels of a bundle of channels provided to an end user, comprising a memory which stores credits, which indicate for each specific channel of the channels, a difference between a number of advertisements provided by an owner of the specific channel that were displayed on other channels and a number of advertisements provided by owners of other channels displayed on the specific channel; and scores indicative of a predicted success of respective advertisements with the end user; and a processor configured to select advertisements to be displayed to the end user, responsive to a function of both the scores and the credits.

Optionally, the scores represent an estimated average number of hours that the end user will spend watching the channel promoted by the advertisement following viewing the advertisement. Optionally, the scores represent an increase in time the user will view the channels of the bundle following viewing the advertisement. Optionally, the processor includes a cache memory which stores for each end-user, a list of channels that the end-user has not viewed in the recent period, ordered according to a priority of providing promotion advertisements for the channel Optionally, the processor is configured to select advertisements to be displayed to an end-user, from the list of channels of the end-user, if the list has not expired, and to select advertisements to be displayed from a default list, if the list of channels of the end-user has expired. Optionally, the processor is configured to determine the list of channels of the end-user when determined that the list of channels of the end-user has expired.

The present invention will be more fully understood from the following detailed description of the embodiments thereof, taken together with the drawings in which:

### BRIEF DESCRIPTION OF THE DRAWINGS

FIG. 1 is a block diagram that schematically illustrates an advertisement insertion system, in accordance with an embodiment of the present invention;

FIG. 2 is a schematic illustration of data structures of database, in accordance with an embodiment of the invention;

FIG. 3 is a flowchart of acts performed by a feature extraction unit, in accordance with an embodiment of the invention; and

FIG. 4 is a flowchart of a method of operation of an ad pool system, in accordance with an embodiment of the invention.

### DETAILED DESCRIPTION OF EMBODIMENTS

### OVERVIEW

Embodiments of the present invention that are described herein provide a credit-based barter scheme for cross insertion of advertisements between channels of a bundle. In addition to the credits, the barter scheme uses scores representative of predictions of the effectivity of the advertisements and selects the advertisements based on both the scores and the credits.

Another aspect of some embodiments of the invention relates to a method of collecting information on viewership of television channels. The method includes filing low value bids for advertisement slots in the television channels, collecting the bid logs of the filed bids and extracting viewership information from the bid logs. The viewership information may be used in advertisement selection, television content selection, channel distribution decisions and/or any other decision relating to television broadcast.

### SYSTEM DESCRIPTION

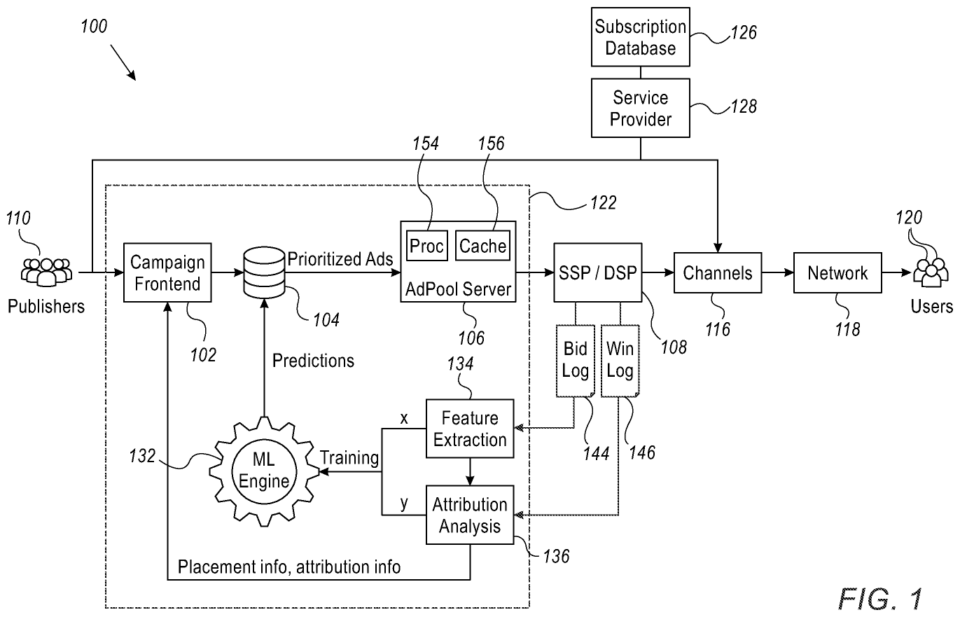

FIG. 1 is a block diagram that schematically illustrates an advertisement insertion system 100, in accordance with an embodiment of the present invention. As shown in FIG. 1, publishers 110 generate channels 116 which are provided together in a bundle of channels over a communication network 118 to end users 120, by a service provider 128 Channels 116 include advertisement slots which are filled by an ad server 108, such as a supply side platform (SSP), a demand side platform (DSP) or any other ad exchange server, using methods known in the art.

In accordance with embodiments of the invention, an ad pool system 122, provides ad server 108 with indications of advertisements to be inserted into slots which could not be sold. In some embodiments, ad server 108 operates in a waterfall manner, in which the advertisements are ordered in a list according to price. To fill a slot, ad server 108 goes down the list and selects the first advertisement on the list that can be fit in the slot. In these embodiments, the advertisements from ad pool system 122 are optionally placed at the bottom of the list with a price tag of zero or a very low sum (e.g. $0.01), such that they will be used to fill empty slots that cannot be filled by a paying advertiser. Ad pool system 122 may be provided as an integral unit of service provider 128, or may be provided separately.

In accordance with some embodiments of the invention, the empty slots of each given channel are filled with advertisements provided by publishers other than the publisher generating the given channel, in accordance with a credit-based barter scheme. For example, publishers 110 may provide promotional ads, directed at increasing viewership of their channels 116.

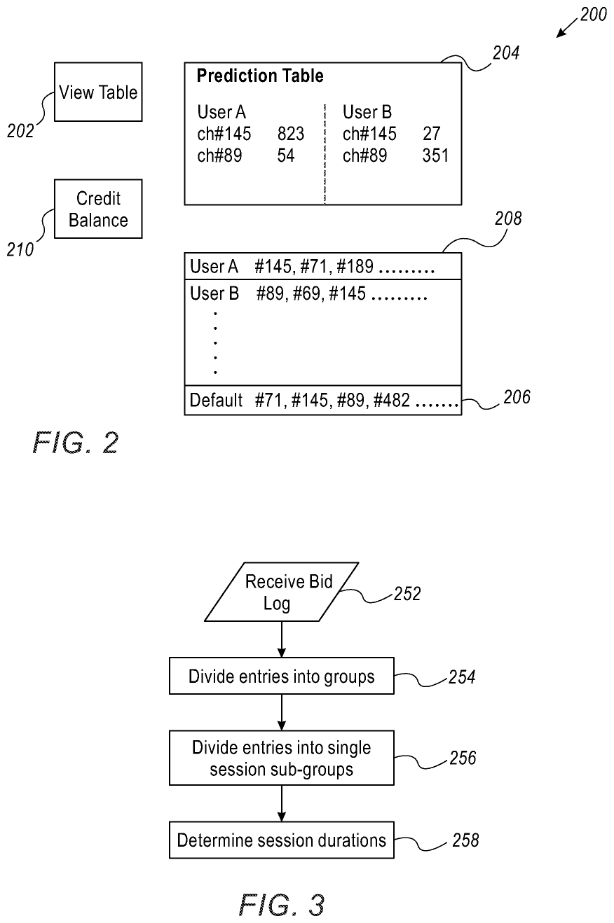

Ad pool system 122 comprises a campaign front end 102 which receives advertisements and corresponding targeting parameters and campaign timing (e.g., duration. start date, expiry date), from publishers 110. An ad pool server 106, including a processor 154 and a cache memory 156, selects advertisements and provides them to ad server 108. In accordance with embodiments of the invention, the selection of the advertisements is based on both the credit based barter scheme and the scores of the advertisements. A database 104 stores information on the channels, used in selecting the advertisements provided by ad pool server 106, as is now described with reference to FIG. 2.

FIG. 2 is a schematic illustration of a data structure 200 of ad pool system 122, stored in database 104 and cache memory 156, in accordance with an embodiment of the invention. Data structure 200 optionally includes a view-table 202, which indicates for each user, the total time the user viewed each of the channels during a recent period, such as 4 weeks. Data structure 200 also includes a prediction table 204, which includes for each end-user 120, a list of the channels of the bundle that the end user did not watch in the recent period, along with a corresponding score, assigned to corresponding promotion advertisements of the channels, for the specific end user 120. The score is optionally a prediction of the success of the advertisement on the end user. In some embodiments, the score represents a probability that the end user 120 will view the channel promoted by the advertisement following display of the advertisement. Alternatively or additionally, the score represents an estimated average number of hours that the end user 120 will spend watching the channel promoted by the advertisement following viewing the advertisement, during a specific duration after viewing the advertisement (e.g., a week). Further alternatively or additionally, the score represents an estimated increase in time the user will view the channels of the bundle. Additional details of the possible scores to be used and their calculation are discussed hereinbelow.

Data structure 200 optionally additionally stores for each publisher 110, a credit balance 210 representing a difference between the number of slots that the publisher provided to other publishers and the number of advertisements of the publisher that other publishers displayed. Optionally, each time an advertisement of a first publisher is displayed in a channel of a second publisher, the credit of the first publisher is decremented by one and the credit of the second publisher is increased by one.

In addition, data structure 200 optionally includes an advertisement priority table 208, which includes for each end-user, a list of channels that the end-user has not viewed in the recent period, ordered according to a priority of providing promotion advertisements for the channel The priority order in advertisement priority table 208, optionally takes into account both the score assigned for the end user to the channel, and the credit of the channel. In some embodiments, a weighted priority score (WPS) is calculated as:

WPS =Score+combined_weight*Credit (2)

The value of combined-weight is optionally selected such that it both normalizes the score and the credit to a similar scale and gives the credit a desired weight in the selection of the advertisements. Alternatively, instead of using a single weight for both normalization and weighting, the normalization may be performed separately. For example, the following equation may be used:

$$WPS = w 1 \frac{s c o r e - a v e rage ( score )}{standard deviation ( score )} + ( 1 - w 1 ) * \frac{credit - a v e rage ( credit )}{standard deviation ( credit )} \qquad ( 2 )$$

In equation (2), the average and standard deviation of the score and credit are taken, for example, over all the channels for the specific user. The normalization in equation (2) brings both the score and the credit to a scale of between 0 and 1. The weight w1 is then used to set the impact of the credit versus the impact of the score. A high weight value would prevent large gaps in the credit values of different channels, at the expense of relatively low consideration of the scores. A low weight value would allow relatively large gaps between the channel credits, but would increase the efficiency of the advertisements. In some embodiments, the weight after normalization, such as the weight w1 of equation (2), is selected to be about 0.5, providing about equal impact to the scores and the credits. In other embodiments, the scores are provided a larger weight, so that the impact of the scores is at least 75%, at least 80% or even at least 90%.

In some embodiments, the weight (e.g., w1) is dynamically adjusted according to the current state of the credits of different publishers. Optionally, when the deviation between the credit values of different publishers, for example as measured by the standard deviation, is relatively high, the weight given to the credits is increased. Conversely, when the deviation between the credit values of different publishers is low, the weight given to the credits is decreased.

Alternatively or additionally, when the credit of a specific publisher reaches an upper threshold, the advertisements of that publisher are not inserted to slots of other publishers. Further alternatively or additionally, the number of credits that a specific publisher is allowed to consume in a given period (e.g., every day) is capped to prevent channels from increasing their credit debt at a high rate. Optionally, the cap of allowed credits to be consumed per period is adjusted separately for each channel, according to the number of credits the channel has accrued and/or the rate at which the channel accrues credits. Optionally, a channel with a high surplus of credits is allowed to consume in the time span at least the number of credits that were accumulated. Alternatively or additionally, the cap of credits to be consumed in the given period is set to about the average rate at which the channel generates credits, that is the rate at which the channel hosts advertisements of other channels. In some embodiments, the rate at which a channel generates credits is calculated as an average over a window including a recent number of periods (e.g., between 7-21 recent periods). Optionally, all the periods are given equal weight in calculating the average. Alternatively, higher weight is given to recent periods. In some embodiments, a low pass filter (LPF) such as an infinite impulse response (IIR) LPF calculates the average rate of credit generation. The cap is optionally set to the calculated average, or to a level slightly higher than the calculated average, such as 10% higher or higher by a fixed number. In some embodiments, the level above the calculated average is set according to the surplus or deficit in credits of the channel.

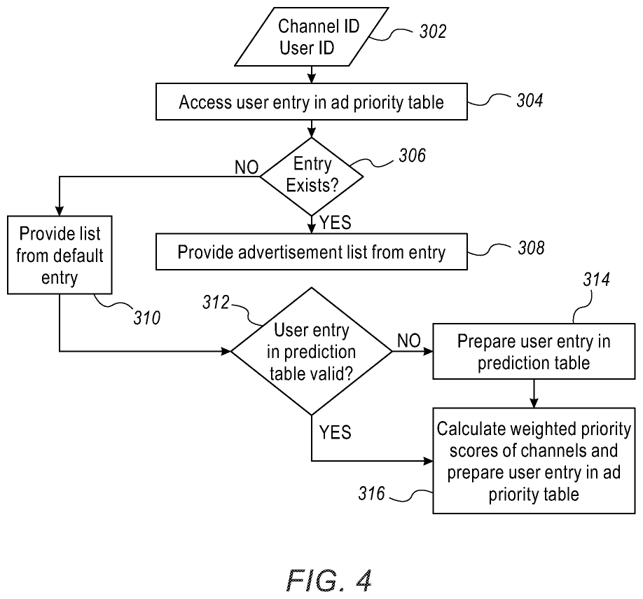

Advertisement priority table 208 optionally includes a default entry 206, which lists the channels in the order of their credit balance without relation to the predicted scores. Default entry 206 is used when an entry for a specific user is not available or is not up to date, as discussed hereinbelow with reference to FIG. 4.

View-table 202 is optionally updated periodically, for example once a week. It is noted however, that the update may be performed more often, for example at a rate of less than 6 days, less than 3 days, or even less than every 24 hours, or less often, for example at a rate of at least 10 days or even at least 15 days. Prediction table 204 is optionally updated following the update of view-table 202, such that it is updated at the same rate as view-table 202. View-table 202 and prediction table 204 are optionally stored in database 104. Database 104 optionally includes a suitable data warehouse and/or long-term storage, such as Snowflake, Amazon Web services (AWS) or SageMaker.

Default entry 206 is optionally updated more often than the update of view-table 202, for example at a rate of less than every 24 hours, less than every 5 hours or even less than every two hours. In one embodiment, the default list 206 is updated once an hour.

The entries of advertisement priority table 208 are optionally calculated for each viewing session of a channel by an end-user. Optionally, the entries of advertisement priority table 208 have a time to live (TTL) of the length of time between consecutive advertisement breaks (e.g., 15 minutes). If a request for an entry in table 208 is received after the TTL time has passed since the last access to the entry, the entry is recalculated, as the previous session has probably ended and the current requested entry belongs to a new session. As advertisement priority table 208 is continuously used and is updated at a high rate, advertisement priority table 208 is optionally stored in cache memory 156 of processor 154 of ad pool server 106, using a fast data structure store, such as REDIS. The access to cache memory 156 is optionally at least 10 times or even at least 100 times faster than the access to database 104.

Referring again to FIG. 1, ad pool system 122 further comprises a machine learning engine 132, which assigns the scores in database 104. Optionally, the scores are assigned based on the behavior of end users 120 similar to the end user for which the score is being assigned. In some embodiments, the similarity between end users is determined based on the channels they viewed. Alternatively or additionally, the similarity between end users is determined based on demographic information of the end users.

Optionally, a plurality of features are determined from the information on the channels viewed by the end users and the features are used in determining the similarity between users. In some embodiments, the features include some or all of the following features which are independent of the specific advertisement and depend on viewership information of the user:

a) the hours of viewing (HOV) the end user spent on each channel

b) the number of channels watched by the end user

c) the total HOV of the end user in a recent time frame

d) how long the end user is active on the service providing the bundle of channels

e) the average session duration watching a single channel

f) the average session duration watching any of the channels in the bundle, wherein the session is considered to end when the end user does not watch any of the channels in the bundle

g) the percent of time the end user spent on each genre type

h) average and/or standard deviation of the number of daily channels a user watched

i) total number of different services providing bundles of channels, that the user is subscribed to and/or actively uses

j) an item based collaborative filtering rating, such as a Pearson-based recommendation score

Alternatively or additionally, the features include some or all of the following features which relate to general information on the end user and do not relate to viewership:

k) demographic information about the end user, such as age and/or gender

l) geographic location of the end user

In some embodiments, the features also include one or more features dependent on a specific advertisement, such as:

1) the number of times the person saw the advertisement

2) a generality level of the advertisement (e.g., whether the advertisement relates to the channel in general, to a specific recurring program or series or to a specific movie or series chapter)

3) the duration of the advertisement

4) a number of different scenes in the advertisement

5) a class of the creative of the advertisement

6) a level of reference to the advertised channel (e.g., whether there's a voiceover or overlays defining clearly the channel number and/or the service name)

In some embodiments, the channels are classified into genres and in determining the time an end user spent on a genre type, ad pool system 122 determines the time the end user spent watching the channels belonging to the genre. Alternatively, the programs are classified into genres and the classification of the end user's viewership is performed per program.

The features are optionally determined for the entire duration for which the end user is a subscriber of the channels 116. Alternatively, the features are determined for a recent time frame. The recent time frame is optionally shorter than 100 days, shorter than 70 days, shorter than 40 days or even shorter than 15 days. For example, the recent time frame is a month or two weeks.

In some embodiments, a feature extraction unit 134 determines the features based on information received from service provider 128, for example from a subscription database 126 of service provider 128. Alternatively or additionally, the features dependent on viewership information are calculated by feature extraction unit 134 from a bid log 144 produced by ad server 108, using methods discussed below with reference to FIG. 3.

Bid log 144 is optionally supplied to ad pool system 122 based on a cooperation between ad pool system 122 and service provider 128, which manages ad server 108. Alternatively, bid log 144 is supplied to ad pool system 122 based on a bidding activity performed by ad pool system 122. This alternative may be used to collect information on the viewing habits of end users 120 of channels provided by other service providers than service provider 128. Collection of information from other service providers 128, allows for a more complete picture of the channels viewed by the end users.

As known in the art, bid log 144 generally includes a list of the advertisement bids received by ad server 108. The bid log 108 is provided to the entities who submitted bids. Generally, bid log 144 includes for each bid for a slot in a channel to be filled by an advertisement, some or all of the following details:

1) IP address, or other user ID, of the user to receive the advertisement

2) information on the device of the user to receive the advertisement (e.g., device type, device ID)

3) content identifier of the content including the slot (e.g., bundle ID, channel ID, program ID)

4) service provider ID

5) a time stamp of the slot

6) a duration of the slot

FIG. 3 is a flowchart of acts performed by feature extraction unit 134, in accordance with an embodiment of the invention. The method begins with feature extraction unit 134 receiving (252) from bid log 144, a batch of bid entries for a given duration. The entries are divided (254) into groups assumed to relate to the same viewing user and channel, such as having entries including the same user ID, service provider ID and content identifier. The entries in each group are further divided (256) into sub-groups relating to a single session. Optionally, the division into sub-groups is performed based on the time stamps of the bid entries, where entries separated by a time larger than a threshold are considered as belonging to different sub-groups. For each sub-group, the duration of the corresponding session is determined (258) as the time difference between the first and last bid entries in the sub-group, together with a correction factor for the viewing time before the first bid entry and/or after the last bid entry in the sub-group. In some embodiments, the correction factor is set to half the average time between advertisements for the service provider and/or bundle to which the sub-group relates.

In some embodiments, in order to receive access to bid logs of service providers 128 not associated with ad pool system 122, ad pool system 122 files bids for advertisement slots on channels of interest. Optionally, in order to avoid winning the auctions for the slots, the filed bids are with very low price offers, which ensure that the bids will not win the bids, or even if they win will cost very little. In some embodiments, the price offers of the bids are so low that even if there are no other bids for the slots the bids will be rejected by the slot owner.

Optionally, the price offers of the bids are lower than 20% of the average winning offer, lower than 10% of the average winning offer, lower than 5% of the average winning offer, or even lower than 1% of the average winning offer. The bid values may be the lowest possible value possible that is greater than 0, e.g., $0.01.

The filed bids are optionally directed to all possible slots on all channels of all service providers. Thus, information is collected on viewership of a large variety of channels. Alternatively, bids are filed only for a subgroup of service providers and/or channels. In some embodiments, on some or all channels bids are not filed for all slots, but rather bids are filed for slots of the channel at a lower rate, for example every second or every third slot. This reduces the number of bids filed, at the cost of reduced accuracy of the measurements of the durations of the viewing sessions,

The information on the channels viewed by users determined from bid logs 144 may be used for other purposes than feature extraction by feature extraction unit 134 for training of machine learning engine 132. In some embodiments, the information on the channels viewed by users is used to determine which content to acquire and/or offer customers, and/or in setting the times at which content is broadcast (e.g., broadcasting more popular programs in prime time). Alternatively or additionally, the information on the channels viewed by users is used in advertising sales, such as in selecting channels in which to purchase advertisement slots and/or in determining a price to pay and/or request for a given slot. Further alternatively or additionally, the information on the channels viewed by users is used in making channel distribution decisions such as selecting a service provider to broadcast a specific channel. Alternatively to collecting the viewership information from bid log 144, the viewership information is collected from auction logs.

Optionally, machine learning engine 132 receives the features of an end user and provides a corresponding value of the score, based on a previously generated trained model. The model is optionally trained using training data of end users collected during a training period. Based on the training data, scores are determined for the end users in the training data by an attribution analysis unit 136 and the training is based on these scores.

As discussed above, in some embodiments, the score represents a probability that the end user will be convinced by the advertisement. In some of these embodiments, in the training, a binary score which receives either a “converted” value or a “not converted” value. is used. Optionally, a user who after viewing an advertisement viewed the channel promoted by the advertisement, within a given time frame (e.g., three days, a week, two weeks) after viewing the advertisement, is assigned a “converted” score. In some embodiments, only end users 120 who did not view the promoted channel in a given time frame (e.g., a week, two weeks, 28 days) before viewing the advertisement are taken into consideration in training machine learning engine 132. Alternatively, the score assigned to users who viewed the promoted channel in the given time frame before viewing the advertisement is set to “not converted”, as the advertisement is assumed to not have influenced the end user. Further alternatively, users who showed a substantial increase in the time they spent viewing a channel, after viewing a promotion advertisement are assigned a “converted user” value. Information on the extent to which a user views a channel promoted by an advertisement after viewing the advertisement, is referred to herein as conversion information.

In other embodiments, the score is set to the difference between the time spent viewing the channel before the advertisement was viewed and the time spent on the channel after the advertisement was viewed. In some of these embodiments, only users who did not view the channel before the advertisement are taken into consideration. In other of these embodiments, users who viewed the channel before viewing the advertisement are taken into consideration. Further alternatively, the score is set to a difference between the total daily average hours of viewership on all participating channels after viewing the advertisement, relative to the value before viewing the advertisement.

The scores used in the training are optionally generated by attribution analysis unit 136, based on information received from a win log 146 from ad server 108 and/or any of the information collected by feature extraction unit 134. Win log 146 provides information on the advertisements that end users viewed, while feature extraction unit 134 provides information on the channels they viewed.

In some embodiments, machine learning engine 132 uses linear regression and/or polynomial regression in generating a model which fits the training data. Alternatively or additionally, machine learning engine 132 comprises a support vector machine, a decision tree, a recurrent neural network and/or a random forest classifier. It is noted, however, that any other suitable machine learning method may be used by machine learning engine 132.

The advertisement insertion system 100 shown in FIG. 1 is an example configuration that is chosen purely for the sake of conceptual clarity. In alternative embodiments, any other suitable system can be used. The various elements of system 100, and in particular the elements of ad pool system 122, may be implemented using hardware/firmware, such as in one or more Application-Specific Integrated Circuit (ASICs) or Field-Programmable Gate Array (FPGAs). Alternatively, some system elements may be implemented in software or using a combination of hardware/firmware and software elements. In some embodiments, the components of system 100, such as machine learning engine 132, processor 154 of ad pool server 106, campaign frontend 102, feature extraction unit 134 and/or attribution analysis unit 136, comprise general-purpose and/or dedicated purpose (e.g., a digital signal processor) processors, which are programmed in software to carry out the functions described herein. The software may be downloaded to the processors in electronic form, over a network, for example, or it may, alternatively or additionally, be provided and/or stored on non-transitory tangible media, such as magnetic, optical, or electronic memory. Each of the elements of ad pool system 122 shown separately in FIG. 1 may be implemented by a separate hardware processor or several (or even all) of the elements may be implemented together on a single hardware unit.

Alternatively to assigning scores by machine learning engine 132, scores may be assigned using any other method known in the art. For example, an item based collaborative filtering rating, such as a Pearson-based recommendation score, may be used as the score of the advertisement. In some embodiments, in order to determine a score for a specific channel that was not viewed recently by a given user, ad pool system 122 determines an average level of viewing other channels by users who viewed the specific channel The score of the given user is assigned based on the similarity of the viewership of the other channels by the given user to the average level. Alternatively or additionally, the score of the given user is assigned to a predicted HOV for the specific channel, which is calculated as a sum of the HOV of the channels the user watched, with the HOV of each channel multiplied by a correlation factor of the channel to the specific channel The correlation factor is optionally a Pearson correlation calculated based on the ratio of HOV between the two channels among the other users.

FIG. 4 is a flowchart of a method of operation of ad pool system 122, in accordance with an embodiment of the invention. When ad server 108 is required to insert advertisements into slots of a specific channel for a specific end user 120, the ad server provides (302) identification numbers of the specific channel and the specific end user to ad pool server 106. Ad pool server 106 attempts to access (304) an entry corresponding to the specific end user in advertisement priority table 208. If (306) the entry exists and has not expired, ad server 108 passes (308) a list of advertisements of the channels in the entry to ad server 108, while removing the identification number of the specific channel, if it is in the list, so that the specific channel will not display its own advertisement using the credit based scheme. If (306) the entry does not exist or it expired, ad pool server 106 provides (310) a list of advertisements based on default entry 206. In addition, an entry in advertisement priority table 208 is prepared for the specific user, by calculating (316) for each channel the weighted priority score of the channel, and selecting a predetermined number of channels (e.g., 10) with the highest weighted priority scores. In calculating the weighted priority scores, the scores of the channels are taken from prediction table 204 and the credits from credit balance 210. If (312), however, the user entry in prediction table 204 expired or does not exist, the user entry in prediction table 204 is calculated (314) by machine learning engine 132.

In some embodiments, a channel may be associated with multiple promotional advertisements. In providing the list of advertisements to ad server 108, for such channels, one of the advertisements of the channel is selected by as pool server 106. The selection may be based on a round robin scheme, random selection or any other suitable scheme.

While in the above description each display of an advertisement in a slot is worth a single credit, such that all slots are equal, in some embodiments the credit scheme may be weighted based on attributes of the end user to which the advertisement is displayed. In some embodiments, the credits of slots and advertisements may be weighted based on the average cost per impression (CPM) of the end user. For example, channels shown to viewers having a high average CPM may be entitled to 2 credits for each slot filled and channels are charged 2 credits for each advertisement shown to high average CPM viewers. Alternatively or additionally, the number of credits provided for a slot depends on the actual conversion success with the end user. For example, a channel displaying an advertisement in one of its slots may receive a single credit for the display of the advertisement, and extra bonus credits may be allotted later, if the end user was converted by the advertisement. In some embodiments, the number of credits provided for an advertisement depends on the device on which the channel to which the advertisements are inserted, is displayed. The term device is used herein to refer to the hardware device and/or to the software managing the display. For example, advertisements placed on a channel displayed on a TV screen may receive more credits than advertisements shown on a computer web browser or a mobile device game.

In the above description, it is assumed for simplicity that each publisher provides a single channel. Alternatively, a plurality of channels may be provided by a single publisher. In such cases, the publisher providing multiple channels has separate credit balances managed for each channel. Alternatively, the publisher may have a single credit balance managed for multiple channels.

In some embodiments, campaign front end 102 provides feedback to publishers on the display and success of the advertisements. The feedback optionally includes the number of people to which the advertisements were displayed, the number of people converted following the viewing of the advertisement, the number of hours the converted viewer watched the channel promoted by the advertisement and/or the revenue received due to the increase in viewing the channel due to the advertisement. Optionally, the revenue is displayed along with indication of the cost of the advertisements.

It will be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A method of assigning advertisements to slots in video channels of a bundle of channels provided to an end user, comprising:
managing credits, for each specific channel of the channels, indicative of a difference between a number of advertisements provided by an owner of the specific channel that were displayed on other channels and a number of advertisements provided by owners of other channels displayed on the specific channel;
calculating, for a plurality of advertisements, scores indicative of a predicted success of the advertisement with the end user; and
selecting an advertisement to be displayed to the end user, responsive to a function of both the calculated scores and the managed credits.

2. The method according to claim 1, wherein managing the credits comprises assigning different numbers of credits for displaying advertisements, responsive to attributes of a viewer to which the advertisements are displayed.

3. The method according to claim 1, wherein managing the credits comprises assigning different numbers of credits for displaying advertisements, responsive to attributes of a device on which the advertisements are displayed.

4. The method according to claim 1, wherein calculating the scores comprises calculating by a machine learning engine.

5. The method according to claim 4, wherein calculating the scores comprises training the machine learning engine to identify end users having features similar to users who following the viewing of a promotional advertisement, viewed the channel promoted by the promotional advertisement.

6. The method according to claim 4, wherein calculating the scores comprises training the machine learning engine based on tracking viewership of similar users.

7. The method according to claim 4, wherein calculating the scores comprises training the machine learning engine based on features of the viewership of the video channels by a plurality of end users, and conversion information on the end users.

8. The method according to claim 4, wherein calculating the scores comprises calculating Pearson correlation based recommendations.

9. The method according to claim 1, wherein calculating the scores comprises calculating a prediction of a duration the end user will view a channel promoted by the advertisement, following viewing the advertisement.

10. The method according to claim 1, wherein calculating the scores comprises calculating a prediction of an increase in a time the user will spend in viewing the channels of the bundle, following viewing the advertisement.

11. The method according to claim 1, wherein selecting the advertisement to be displayed comprises selecting responsive to a weighted sum of the calculated scores and the managed credits.

12. The method according to claim 11, and comprising periodically updating weights of the weighted sum.

13. The method according to claim 1, wherein selecting the advertisement to be displayed comprises selecting for slots that were not filled in a bidding based on payment.

14. The method according to claim 1, further comprising setting for each of the channels a cap on the number of credits it may consume per a given period, and wherein selecting the advertisement to be displayed is performed additionally responsive to the caps of the channels.

15. The method according to claim 1, wherein setting the cap of each channel comprises calculating an average rate of credit generation by the channel and setting the cap responsive to the set calculated average.

16. A method of controlling broadcast of video channels, comprising:
filing bids for a plurality of slots in a plurality of broadcast channels transmitted to end users, wherein the bids are filed with low price offers;
receiving bid logs, by a processor, responsive to the filed bids;
grouping entries of the received bid logs into single-session groups, by the processor;
estimating a session duration for each of the single-session groups; and
controlling, by the processor, supply of broadcast channels to one or more of the end users, responsive to the estimated session durations.

17. The method of claim 16, wherein filing the bids comprises filing on channels of a plurality of different service providers.

18. The method of claim 16, wherein grouping the entries comprises grouping entries into groups of the same user ID, service provider ID and content identifier.

19. The method of claim 16, wherein grouping the entries comprises grouping the entries, such that entries separated by a time longer than a threshold are considered as belonging to different groups.

20. An apparatus for assigning advertisements to slots in video channels of a bundle of channels provided to an end user, comprising:
a memory which stores:
credits, which indicate for each specific channel of the channels, a difference between a number of advertisements provided by an owner of the specific channel that were displayed on other channels and a number of advertisements provided by owners of other channels displayed on the specific channel; and
scores indicative of a predicted success of respective advertisements with the end user; and
a processor configured to select advertisements to be displayed to the end user, responsive to a function of both the scores and the credits.

21. The apparatus of claim 20, wherein the scores represent an estimated average number of hours that the end user will spend watching the channel promoted by the advertisement following viewing the advertisement.

22. The apparatus of claim 20, wherein the scores represent an increase in time the user will view the channels of the bundle following viewing the advertisement.

23. The apparatus of claim 20, further comprising a cache memory which stores for each end-user, a list of channels that the end-user has not viewed in the recent period, ordered according to a priority of providing promotion advertisements for the channel

24. The apparatus of claim 23, wherein the processor is configured to select advertisements to be displayed to an end-user, from the list of channels of the end-user, if the list has not expired, and to select advertisements to be displayed from a default list, if the list of channels of the end-user has expired.

25. The apparatus of claim 24, wherein the processor is configured to determine the list of channels of the end-user when determined that the list of channels of the end-user has expired.
